(19) United States
(12) Patent Application Publication
(10) Pub. No.: US 2010/0171249 A1
(43) Pub. Date: Jul. 8, 2010

(54) SPRING WITH ENHANCED PRECISION OF ELASTIC ENERGY

(76) Inventor: Chih-Ching HSIEH, Taichung Hsien (TW)

Correspondence Address: SINORICA, LLC, 2275 Research Blvd., Suite 500, ROCKVILLE, MD, 20850, US

(21) Appl. No.: 12/350,509

(22) Filed: Jan. 8, 2009

(51) Int. Cl. F16F 1/06

(52) U.S. Cl. 267/166

(57) ABSTRACT

The invention provides a spring, which has multiple continuously arranged loops. The first and second loops of at least one of the two ends of the spring are fixedly connected with each other. Accordingly, when the first loop of the spring sustains a force, the first loop will not be outward swiveled or laterally displaced. Therefore, the action force applied to the spring can be effectively converted into elastic energy of the spring.

### FIELD OF THE INVENTION

The present invention is related generally to a mechanical element, and more particularly to a spring with better precision of elastic energy.

### BACKGROUND OF THE INVENTION

FIG. 1 shows a conventional spring 10 made of metal wire material with a spiral configuration. The spring 10 has multiple loops 12. When an external force is applied to the spring 10, the loops 12 are twisted to compress or uncompress the spring.

When the spring sustains the force, the action force is sequentially transmitted from the first loop to the second loop. In general, the first loop bears a force greater than that borne by any other loop. Moreover, the first loop 12a of each end is a free loop not like the other loop that is interconnected between a preceding loop and a succeeding loop. Therefore, the first loop is weaker and likely to swivel outward due to twisting.

With respect to a compression spring, the physical properties of the first loop are poorer than those of the other loop. This is because the first loop 12a is cut to form a plane front face 14 normal to the axis of the spring for better contact between the spring and an article. Accordingly, the spring has two flat ends. In this case, the diameter of the wire of the first loop 12a is smaller than that of the other loop. As a result, the first loop 12a has poorer mechanical performance and deteriorated rigidity and is more likely to be flexed and outward swiveled when sustaining external force.

The outward swiveling of the first loop leads to dispersion of the action force. As a result, the action force can be hardly effectively converted into elastic energy of the spring. Moreover, the precision of the elastic energy will be affected. Therefore, the application of such spring is restricted from those fields requiring high-precision elastic energy.

### SUMMARY OF THE INVENTION

It is therefore a primary object of the present invention to provide a spring with enhanced precision of elastic energy.

According to the above object, the spring of the present invention has multiple continuously arranged loops. The first and second loops of at least one of the two ends of the spring are fixedly connected with each other. Accordingly, when the first loop of the spring sustains a force, the first loop will not be outward swiveled or laterally displaced. Therefore, the action force applied to the spring will not disperse and can be effectively converted into elastic energy of the spring to provide precise elasticity value.

Preferably, the fixedly connected section of the first and second loops is positioned at a free end of the first loop.

Preferably, the range of the fixedly connected section of the first and second loops is not larger than one quarter of the circumference of the first loop.

The present invention can be best understood through the following description and accompanying drawings wherein:

### BRIEF DESCRIPTION OF THE DRAWINGS

FIG. 1 is a front view of a conventional spring;

FIG. 2 is a perspective view of a first embodiment of the spring of the present invention;

FIG. 3 is a front view of the first embodiment of the spring of the present invention;

FIG. 4 is a top view of the first embodiment of the spring of the present invention;

FIG. 5 is a sectional view showing an application of the spring of the present invention;

FIG. 6 is a front view of a second embodiment of the spring of the present invention;

FIG. 7 is a front sectional view of a part of a third embodiment of the spring of the present invention;

FIG. 8 is a top view according to FIG. 7;

FIG. 9 is a front sectional view of a part of a fourth embodiment of the spring of the present invention;

FIG. 10 is a top view according to FIG. 9; and

FIG. 11 is a front view of a part of a fifth embodiment of the spring of the present invention.

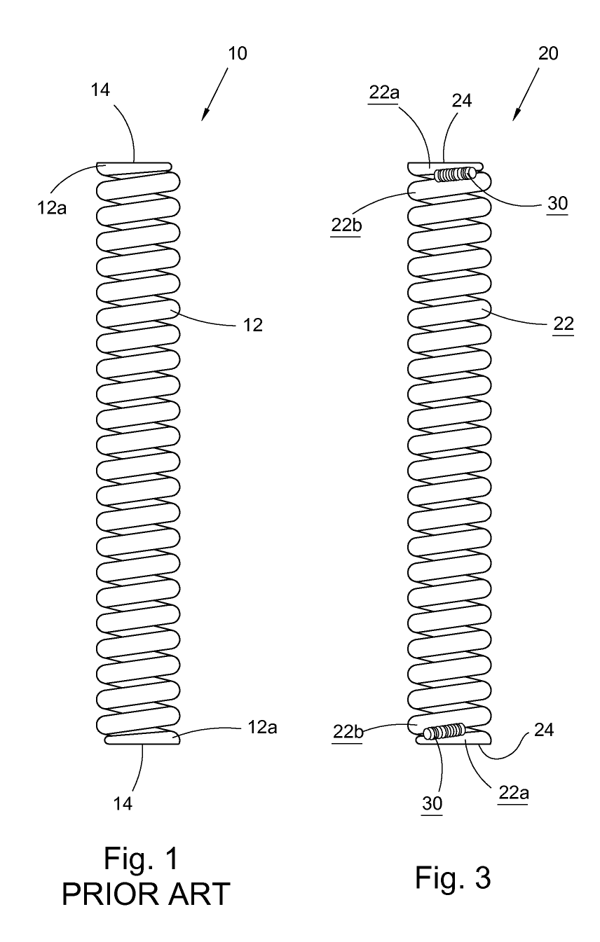

### DETAILED DESCRIPTION OF THE PREFERRED EMBODIMENTS

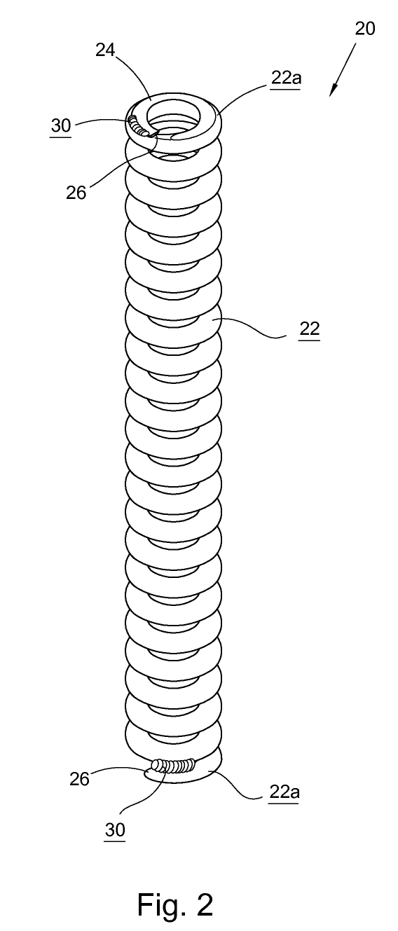

Please refer to FIGS. 2 and 3. According to a first embodiment, the spring 20 of the present invention is a compression spring.

The spring 20 is made of metal wire material with a spiral configuration, and it has multiple continuously connected loops 22. The spring 20 has a top end and a bottom end each having a first loop 22a positioned in an outermost position. The spring 20 has second loops, third loops, and so on, which are sequentially arranged toward a center of the spring. The first loop 22a is usually processed to form a plane front face 24 normal to the axis of the spring for better contact between the spring and an article.

The first loop 22a and the second loop 22b of each end of the spring are substantially rigidly connected with each other. To speak more specifically, a welding material (fixing element) 30 is welded between the first loop 22a and the second loop 22b by means of welding. Accordingly, the two loops 22a, 22b are fixedly connected with each other.

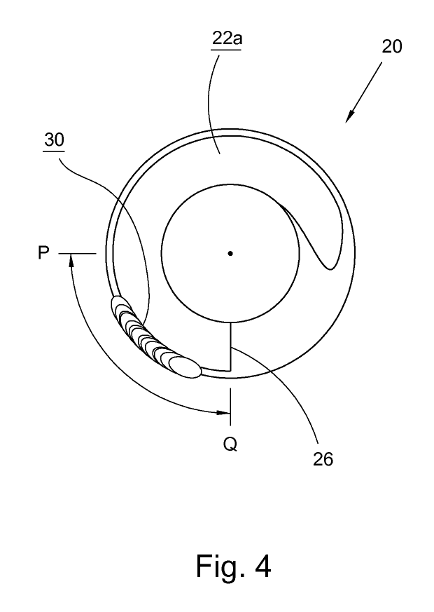

The range of fixed connection can cover the entire circumference of the first loop 22a. That is, the entire circumference of the loop 22a is welded from a free end 26 of the loop 22a by 360 degrees. Preferably, one quarter of the circumference of the first loop is welded as shown by arc between P and Q in FIG. 4. Also, the welding material 30 is preferably positioned at the free end 26 of the first loop. Accordingly, the first and second loops can be normally twisted. It should be noted that the meaning that the fixed connection positioned at the free end of the first loop contains that the fixed connection is in a position near the free end 26 of the first loop as shown in FIG. 4, also as shown in FIG. 8 and FIG. 10.

According to the above arrangement, the first loop 22a that sustains greatest force and is most likely to be swiveled and flexed is fixedly connected with the second loop 22b. Especially, the thinnest free end 26 of the first loop is fixed.

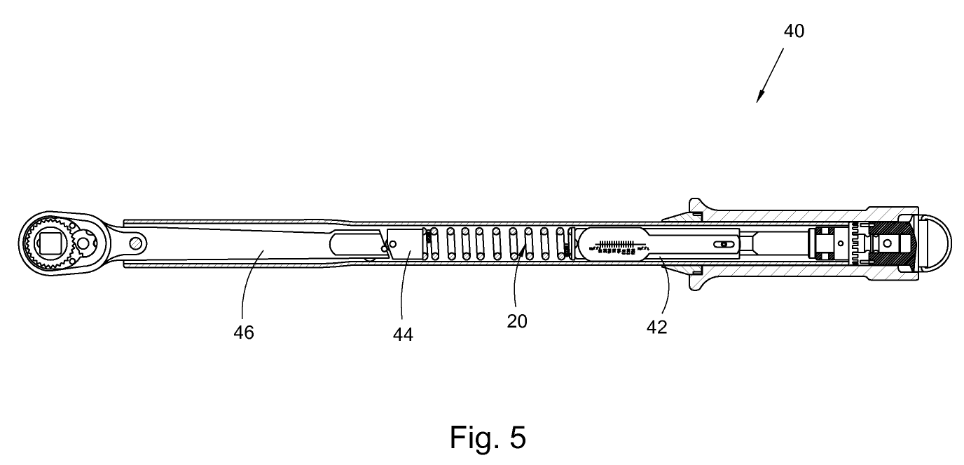

The spring of the present invention is used in those fields that require elastic energy. For example, FIG. 5 shows an application of the spring of the present invention. The spring is installed in a torque wrench 40 with settable torque value. The spring is positioned between a slide block 42 and a push block 44 of the wrench to provide elastic energy. Accordingly, the torque value of slippage of the slide block 44 off a rod body 46 can be adjusted. Such wrench pertains to prior art and is not the subject of the present invention so that it will not be further described hereinafter. The application range of the spring is not limited to the torque wrench.

By means of fixedly connecting the first loop 22a with the second loop 22b, the first loop 22a is located. When the spring 20 sustains an external force, such as a compression force, the first loop 22a with poorest mechanical performance is no more outward swiveled or laterally displaced or deformed. In this case, the action force will not disperse and can be effectively converted into elastic energy of the spring to provide precise elastic energy and elasticity value. Accordingly, the spring is applicable in those fields requiring high-precision elastic energy.

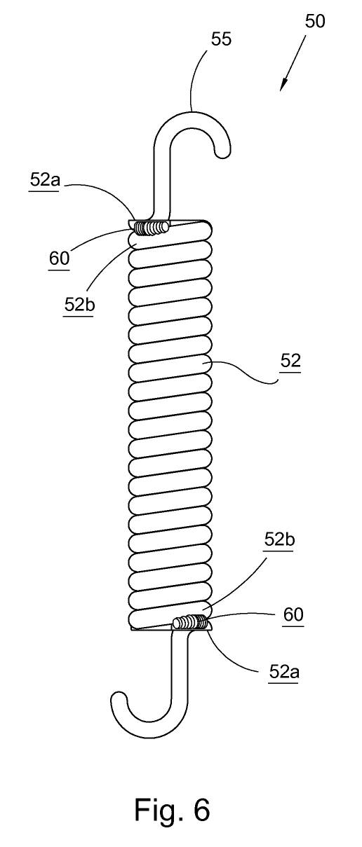

Alternatively, the spring of the present invention can be an extension spring or a torque spring. FIG. 6 shows a second embodiment of the present invention, which is an extension spring 50 having multiple loops 52. Each end of the spring has an extension section 55 connected with the free end of the first loop 52a.

Similarly, a fixing element such as a welding material 60 is fixedly connected between the first loop 52a and the second loop 52b to fix the first and second loops with each other. By means of the fixing element, the mechanical performance of the first loop 52a of the extension spring 50 can be improved.

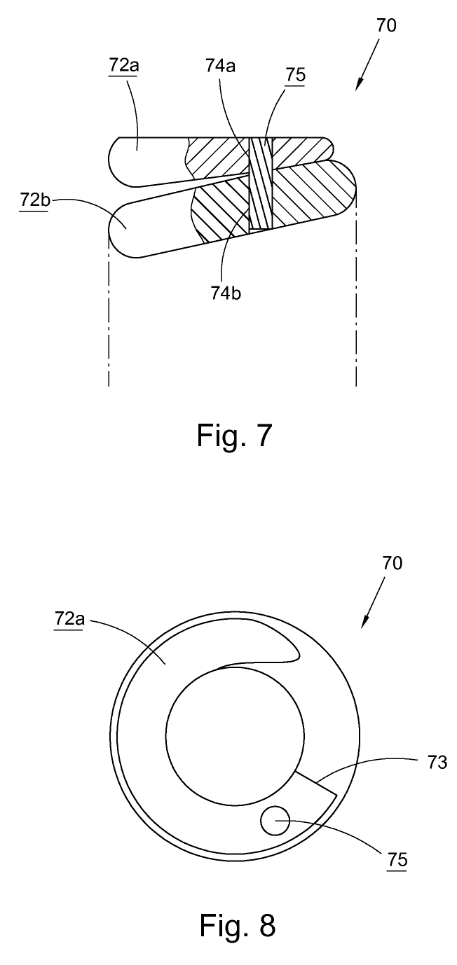

FIGS. 7 and 8 show a third embodiment of the spring 70 of the present invention, in which each end of the spring 70 has a first loop 72a and a second loop 72b. The first and second loops 72a, 72b are respectively formed with insertion holes 74a, 74b in alignment with each other. A fixing element 75, which is a pin, is inserted in the insertion holes 74a, 74b in a tight fit manner to fix the first and second loops with each other. Preferably, the fixing element 75 is fixed in a position close to the free end 73 of the first loop 72a. Preferably, the fixing element is positioned within a range of one quarter of the circumference of the first loop from the free end of the first loop.

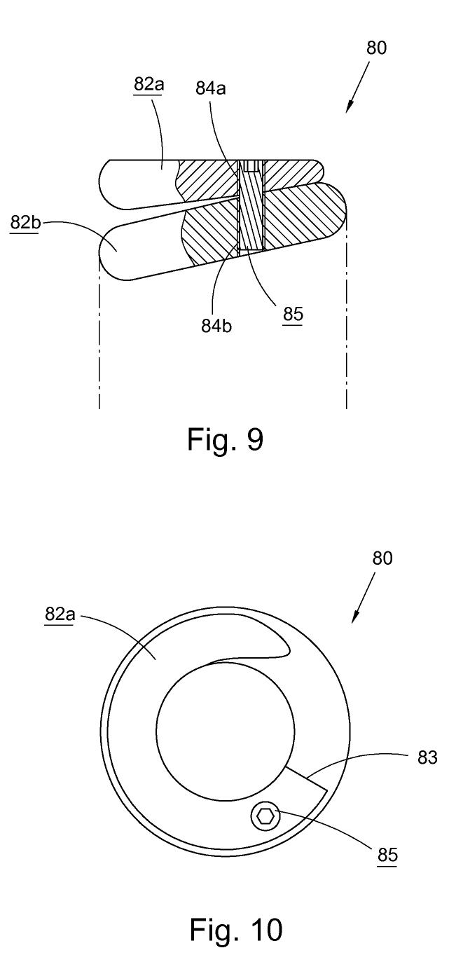

FIGS. 9 and 10 show a fourth embodiment of the spring 80 of the present invention, in which the first and second loops 82a, 82b are respectively formed with thread holes 84a, 84b. A fixing element 85, which is a screw, is screwed into the thread holes 84a, 84b to fix the first and second loops with each other. Similarly, the fixing element 85 is preferably fixed in a position at the free end 83 of the first loop 82a.

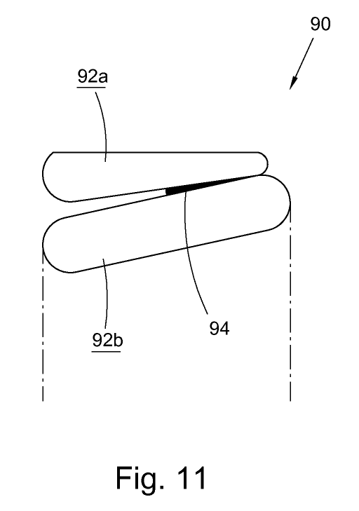

FIG. 11 shows a fifth embodiment of the spring 90 of the present invention, in which the first and second loops 92a, 92b are fixedly connected by means of point welding. Accordingly, the materials of the two loops themselves are directly welded. The fixing position 94 is preferably at the free end of the first loop.

In conclusion, according to the aforesaid, the action force applied to the spring of the present invention can be more effectively converted into elastic energy. Therefore, the precision of elastic energy of the spring is enhanced.

The above embodiments are only used to illustrate the present invention, not intended to limit the scope thereof. Many modifications of the above embodiments can be made without departing from the spirit of the present invention.

What is claimed is:

1. A spring with enhanced precision of elastic energy, the spring being made of metal wire material with a spiral configuration and having multiple continuously connected loops;
the spring having a top end and a bottom end, each of the top end and the bottom end having a first loop positioned in an outermost position and a second loop connected with the first loop, said spring being characterized in that:
the first and second loops of at least one end of the spring being fixedly connected with each other, the fixedly connected section of the first and second loops being within a range of a circumference of the first loop.

2. The spring as claimed in claim 1, wherein the range of the fixedly connected section of the first and second loops is not larger than one quarter of the circumference of the first loop.

3. The spring as claimed in claim 1, wherein the fixedly connected section of the first and second loops is positioned at a free end of the first loop.

4. The spring as claimed in claim 1, wherein the first and second loops are fixedly connected with each other by means of a fixing element.

5. The spring as claimed in claim 2, wherein the first and second loops are fixedly connected with each other by means of a fixing element.

6. The spring as claimed in claim 3, wherein the first and second loops are fixedly connected with each other by means of a fixing element.

7. The spring as claimed in claim 4, wherein the fixing element is welding material.

8. The spring as claimed in claim 4, wherein the first and second loops are respectively formed with an insertion hole; the fixing element is a pin fixedly inserted in the insertion holes.

9. The spring as claimed in claim 4, wherein the first and second loops are respectively formed with a thread hole; the fixing element is a screw screwed in the thread holes.

10. The spring as claimed in claim 1, wherein the first and second loops are fixedly connected with each other by means of welding.

11. The spring as claimed in claim 2, wherein the first and second loops are fixedly connected with each other by means of welding.

12. The spring as claimed in claim 3, wherein the first and second loops are fixedly connected with each other by means of welding.

13. The spring as claimed in claim 10, wherein the first and second loops are fixedly connected with each other by means of point welding.

14. The spring as claimed in claim 1, wherein at least one end of the spring has an extension section connected with the free end of the first loop.

15. The spring as claimed in claim 1, wherein the first and second loops of each end of the spring are fixedly connected with each other.

16. The spring as claimed in claim 4, wherein the first and second loops are respectively formed with a hole; the fixing element is fixedly connected with the holes of the loops.
